(19) United States
(12) Patent Application Publication
(10) Pub. No.: US 2023/0136379 A1
(43) Pub. Date: May 4, 2023

(54) FREE SPACE OPTICAL COMMUNICATION SYSTEM WITH FREE SPACE OPTICAL BEAM SEPARATOR AND POINT-AHEAD

(71) Applicant: SA PHOTONICS, INC., Los Gatos, CA (US)

(72) Inventors: David A. PECHNER, Los Gatos, CA (US); William C. Dickson, Granville, CA (US); Bjoern Hall, Santa Cruz, CA (US); Angus Henderson, San Carlos, CA (US); Andrew Olson, Los Gatos, CA (US); Giorgio Giaretta, Los Gatos, CA (US); Greg G. Mitchell, Elk Grove, CA (US); Mohammad Noshad, Fremont, CA (US)

(21) Appl. No.: 17/977,768

(22) Filed: Oct. 31, 2022

Related U.S. Application Data
(60) Provisional application No. 63/273,850, filed on Oct. 29, 2021.

(51) Int. Cl. H04B 10/118; G02B 6/42

(52) U.S. Cl. CPC H04B 10/118; G02B 6/4225

(57) ABSTRACT

Methods and systems are described for free space optical communication. An example device may comprise an optical beam separator configured to separate a first optical path into a receiving (Rx) optical path for signals received from free space and a transmitting (Tx) optical path for signals being transmitted into free space. The example device may comprise at least one positioner coupled to one or more of the Rx optical path or the Tx optical path. The example device may comprise a controller configured to control the at least one positioner to adjust one or more of the Rx optical path or the Tx optical path to facilitate communication with a remote communication device via free space.

### CROSS-REFERENCE TO RELATED APPLICATIONS

This application is related to U.S. Patent Application No. 63/273,850 filed Oct. 29, 2022, which is hereby incorporated by reference for any and all purposes.

### BACKGROUND

Free space optical communications (FSOC) is a communications technology that uses light propagating in free space to wirelessly transmit data, for example, for telecommunications or computer networking. Free space is a communications medium that can include air, outer space, vacuum, or water, and contrasts with guided wave communications, such as optical fibers. In many embodiments, FSOC is carried over narrow beams of highly collimated light and modulated to carry coded information. These narrow beams may support complex high-bandwidth networks with many interconnections among moving elements, such as large networks of communication satellites. In contrast with other electromagnetic communications means, narrow optical beams can communicate independently with many terminals, even reusing the same wavelength carriers.

In many embodiments FSOC is bidirectional, with encoded beams transmitted in both directions. In other embodiments the communication can be unidirectional, but FSO beams may be transmitted in both directions for tracking purposes. In such embodiments, each FSO terminal, serving as an endpoint for the two beams, may have both a transmitted beam (Tx) and a received beam (Rx). In such embodiments, the two beams may need to be separated, e.g., to prevent the Tx beam from leaking into the Rx beam receiver and/or causing interference which may prevent Rx beam detection. Some Tx/Rx beam separation methods used in previous FSOC systems, such as separate Tx/Rx telescopes, add significant size, weight, power, cost, and complexity increases to the FSOC terminals. Thus, there is a need for more efficient communication devices for free space optical communication.

### SUMMARY

Methods, devices, and systems are disclosed for optical communication. An example device may comprise a first optical path configured to receive and transmit signals via free space. The device may comprise an optical beam separator configured to separate the first optical path into a receiving (Rx) optical path for signals received from free space and a transmitting (Tx) optical path for signals being transmitted into free space. The Rx optical path and the Tx optical path may comprise single mode optical paths (e.g., waveguides, fibers, transport medium)). The device may comprise at least one positioner coupled to one or more of the Rx optical path or the Tx optical path. The device may comprise a controller configured to control the at least one positioner to adjust one or more of the Rx optical path or the Tx optical path with respect to the optical beam separator to facilitate communication with a remote communication device via free space.

An example system may comprise a remote communication device and a local communication device. The local communication device may comprise a first optical path configured to receive and transmit signals via free space. The local communication device may comprise an optical beam separator configured to separate the first optical path into a receiving (Rx) optical path for signals received from free space and a transmitting (Tx) optical path for signals being transmitted into free space. The Rx optical path and the Tx optical path may be single mode optical paths (e.g., single mode optical waveguides, single mode optical fibers). The local communication device may comprise at least one positioner coupled to one or more of the Rx optical path or the Tx optical path. The local communication device may comprise a controller configured to control the at least one positioner to adjust one or more of the Rx optical path or the Tx optical path with respect to the optical beam separator to facilitate communication with a remote device via free space.

An example method may comprise determining, by a local communication device, a directional parameter for free space optical communication with a remote communication device. The local communication device may comprise an optical beam separator configured to separate a first optical path into a receiving (Rx) optical path and a transmitting (Tx) optical path. The Rx optical path and the Tx optical path may be single mode optical paths (e.g., single mode optical waveguides, single mode optical fibers). The method may comprise controlling, based on the directional parameter and by a controller of the local communication device, at least one positioner to adjust a position of one or more of the Rx optical path or the Tx optical path with respect to the optical beam separator to facilitate communication with the remote communication device via free space.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Additional advantages will be set forth in part in the description which follows or may be learned by practice. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate embodiments and together with the description, serve to explain the principles of the methods and systems.

FIG. 1 shows an example free space optical communication system in accordance with the present disclosure.

FIG. 2 shows an example of beam propagation related to an example communication device.

FIG. 3 shows an example optical beam separator.

FIG. 4 shows an example of a point ahead offset between two communication devices.

FIG. 5 shows an optical configuration of an example communication device.

FIG. 6 shows an example positioner for offset control.

FIG. 7 shows example components of an example communication device.

FIG. 8 shows example receiver offset control.

FIG. 9 shows an example point-ahead control system.

FIG. 10 show examples of controlling pointing of an example communication device.

FIG. 11 shows an example method for communication.

### DETAILED DESCRIPTION OF ILLUSTRATIVE EMBODIMENTS

This disclosure relates to free space optical communication (FSO) between two similar or dissimilar communication stations, such as a FSO communication device, terminal, and/or the like. The stations may have significant separation (e.g., tens or thousands of kilometers). The motion of the stations relative to each other may be significant (e.g., tens of meters per second). The separation and relative velocity between, for example, two stations S₁ and S₂ may cause S₂ to move significantly between the time it emits a signal toward S₁ and the time when it receives a return signal from S₁. Therefore, the direction of arrival for S₂ 's signal as observed by S₁ is not the exact reciprocal of the optimal direction of transmission for signals emitted from S₁ to S₂. This disclosure relates to methods by which S₁ may implement (e.g., optimal) transmission to S₂.

The narrow beams used in some FSOC embodiments may demand accurate beam pointing between terminals and render communication unpredictable if the FSO beams miss their intended targets. For example, for communications among satellites in Earth orbit or for communication between ground-terminals and satellites this can be especially challenging. Separation between communication devices may be on the order of hundreds to thousands of kilometers, communication devices may have significant relative velocity, and atmospheric refraction may bend the optical propagation. In some cases, methods to determine time delays, apparent velocity vectors, and other sources of pointing offset from the remote signal's measured Direction of Arrival (DOA) are known. For example, a satellite in orbit at an altitude 500 km above Earth's surface experiences a point-ahead angle of 51 micro-radians (51 μrad) relative to the DOA when communicating with the ground immediately below it. The effect lessens as orbital altitude increases, through a combined effect of reduction in orbital velocity and increased propagation delay. Satellite to satellite point-ahead angles are similar in principle but depend on details of orbital parameters, such as altitude differences, relative orbital inclination, and relative orbital phase. Although aircraft-to-aircraft applications experience point-ahead effects, these may be smaller because distances and velocities are typically smaller.

An angle for transmission of signals may be determined and/or adjusted relative to the direction of arrival DOA (e.g., or relative to a transmission axis) associated with a remote communication device at the time a local communication device receives signal. This angle may be referred to as the transmission (Tx) offset angle α. The Tx offset angle α may be a one component or a two component angular measure. It may be convenient to decompose the Tx offset angle α into “horizontal” and “vertical” components αₕ and α_{ν}. A receiving (Rx) offset angle may also be determined and/or adjusted for purposes of communication with the remote communication device. A general system that manages the offset between Tx and Rx, for point-ahead or other purposes, may require two degrees of freedom to match αₕ and α_{ν}. It is not required to implement both degrees of freedom in either the Tx or in the Rx system. By way of example, it may be an advantage, depending on mechanical and other practical considerations, to configure the Tx so it compensates for αₕ only, and to adjust the telescope axis so it compensates only for α_{ν}, while the Rx detects signal at offset α_{ν}. In such a system, the Rx detector may have ν-offset such that—a, and the Tx ν-offset is zero.

In some implementations, the satellite or other platform may rotate about the optical axis by an angle ϕ, to align the direction of the Tx offset angle α with a specific direction relative to the telescope and Tx-offset mechanism. This may offer an advantage, for example, if this makes αₕ=0 in the rotated frame. Then the Tx-offset mechanism may compensate for the Tx offset angle α with only a change in α_{ν}. In this scenario the Tx-offset mechanism may require only a single degree of freedom to control α_{ν}. In general, these techniques and other disclosed in more detail below may be used to facilitate communication between a local and remote communication device.

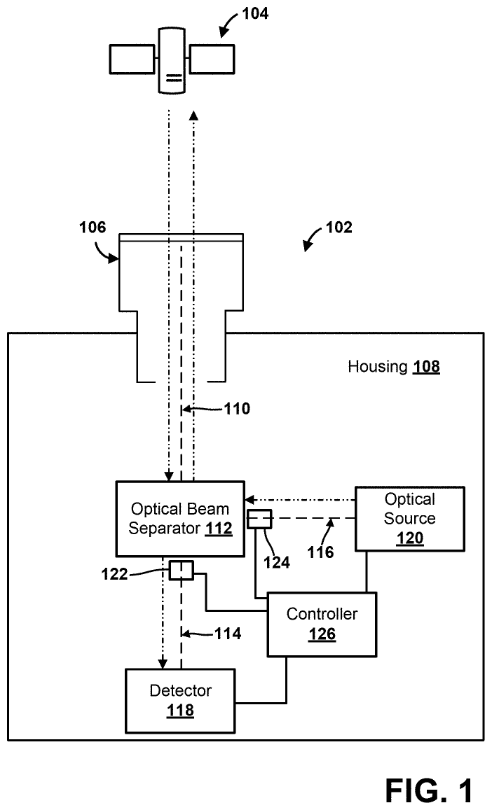

FIG. 1 shows an example free space optical communication system in accordance with the present disclosure. The system may comprise a local communication device 102 configured to communicate with a remote communication device 104. The local communication device 102 may comprise an optical communication device, such as a terminal, station, satellite, and/or the like. The remote communication device 104 may comprise any of the features and/or components of the local communication device 102.

The local communication device 102 may comprise a fore optic 106, such as a telescope. The local communication device 102 may comprise a housing 108. The housing 108 may be coupled to the fore optic 106. The fore optic 106 may provide an optical path into the housing 108.

The local communication device 102 (e.g., the housing 108) may comprise a first optical path 110. The first optical path 110 may be configured to receive and transmit signals via free space, such as signals for communicating with the remote communication device 104. The first optical path 110 may comprise the fore optic 106.

The local communication device 102 (e.g., the housing 108) may comprise an optical beam separator 112. The first optical path 110 may carry both received signals and transmission signals through the housing 108 between the fore optic and the optical beam separator. The optical beam separator 112 may be configured to separate the first optical path 110 into a receiving (Rx) optical path 114 for signals received from free space and a transmitting (Tx) optical path 116 for signals being transmitted into free space. The Rx optical path 114 may comprise a free space optical path, a fiber based optical path, or a combination thereof. The Tx optical path 116 may comprise a free space optical path, a fiber based optical path, or a combination thereof.

The Rx optical path 114 may comprise a single mode optical path. A physical medium in the Rx optical path, such as a waveguide and/or fiber, may support only a single optical mode. The Tx optical path 116 may comprise a single mode optical path (e.g., may be disposed, configured, dimensioned, and/or the like to only support a single mode of light). A physical medium in the Tx optical path, such as a waveguide and/or fiber, may support only a single optical mode. The Rx optical path 114 may comprise a first single mode optical fiber. The Rx optical path 114 (e.g., the first single mode optical fiber) may be optically coupled to a detector 118 for detecting received signals. The Tx optical path 116 may comprise a second single mode optical fiber. The Tx optical path 116 (e.g., the second single mode optical fiber) may be optically coupled with an optical source 120 for generating signals. The optical beam separator 112 may comprise a free space optical beam separator. The optical beam separator 112 may comprise one or more of an optical circulator (e.g., a free space optical circulator), a beam splitter, a plate beam splitter, a polarization beam splitter, or a chromatic splitter.

The local communication device 102 (e.g., the housing 108) may comprise at least one positioner 122, 124. One or more of the at least one positioner 122, 124 may be coupled to the Rx optical path 114. One or more of the at least one positioner 122, 124 may be coupled to the Tx optical path 116. The at least one positioner may comprise a first positioner 122 configured to adjust the Rx optical path 114. The at least one positioner may comprise a second positioner 124 configured to adjust the Tx optical path 116.

The at least one positioner (e.g., the first positioner 122) may be configured to adjust an angle of a signal traversing the Rx optical path 114 (e.g., or adjust the Rx optical path 114 itself, or the angle of a signal as it is emitted from the Rx optical path 114). The at least one positioner (e.g., the first positioner 122) may be configured to adjust the Rx optical path 114 along a single direction, such as a direction orthogonal to a direction of signal propagation. The at least one positioner (e.g., the first positioner 122) may be configured to adjust the Rx optical path 114 in at least two perpendicular directions, such as two direction orthogonal to a direction of signal propagation.

The at least one positioner (e.g., the second positioner 124) may be configured to adjust an angle of a signal traversing the Tx optical path 116 (e.g., or adjust the Tx optical path 116 itself, or the angle of a signal as it is emitted from the Tx optical path 116). The at least one positioner (e.g., the second positioner 124) may be configured to adjust the Tx optical path 116 along a single direction, such as a direction orthogonal to a direction of signal propagation. The at least one positioner (e.g., the second positioner 124) may be configured to adjust the Tx optical path 116 in at least two perpendicular directions, such as two directions orthogonal to a direction of signal propagation.

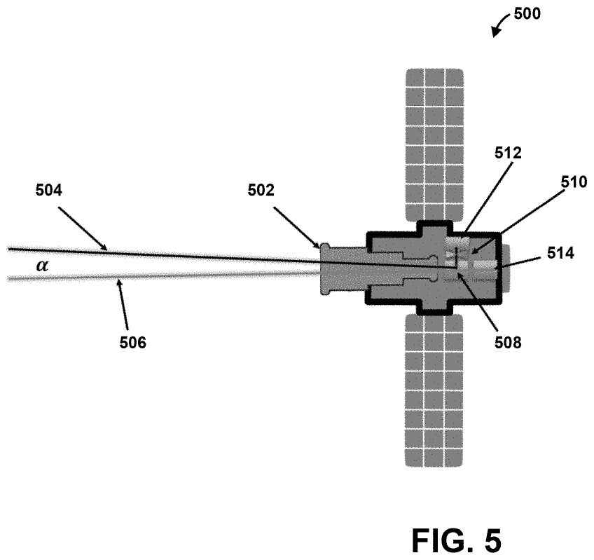

The local communication device 102 (e.g., the housing 108) may comprise a controller 126 configured to control the at least one positioner (e.g., the first positioner 122, the second positioner 124) to adjust one or more of the Rx optical path 114 or the Tx optical path 116 with respect to the optical beam separator to facilitate communication with the remote communication device 104 via free space. The local communication device 102 (e.g., the housing 108) may comprise an offset detector configured to determine alignment signals for communication with the remote communication device. The offset detector may be part of the detector 118 and/or a separate component (e.g., as shown in FIG. 5). The controller 126 may control the at least one positioner 122, 124 based on the alignment signals. The controller 126 may control other alignment and positioning. The local communication device 102 may comprise a gimbal configured to adjust a direction of the first optical path 110 and/or the local communication device 102. The controller 126 may control the gimbal to adjust the direction of the first optical path 110 and/or the local communication device 102. The controller 126 may otherwise adjust the local communication device 102 according to a variety techniques as disclosed further herein.

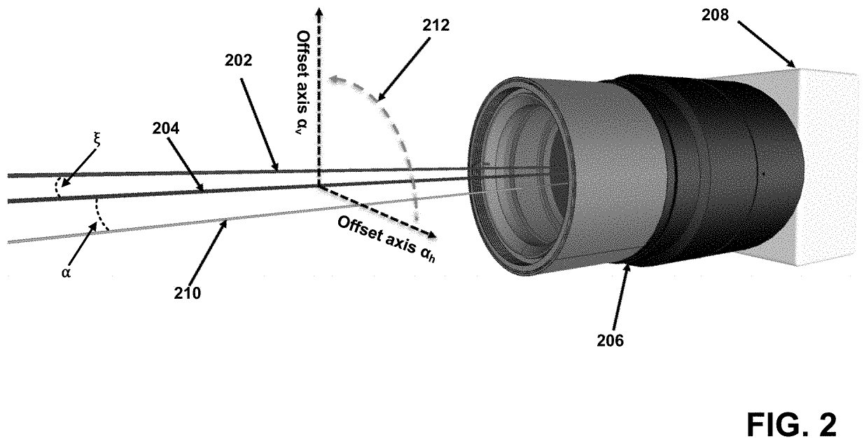

FIG. 2 shows an examples of beam propagation related to the example communication system of FIG. 1. An example communication device is shown having a telescope 206 (e.g., the fore optic 106 of FIG. 1) and a housing 208 (e.g., the housing 108 of FIG. 1). The telescope 206 may comprise a telescope optical axis 204 extending in a direction that the telescope 206 is pointing. The telescope 206 may be configured to receive incoming optical signals 202, transmit outgoing optical signals 210, or a combination thereof. An incoming optical signal 202 may be at a first angle relative to the optical axis 204.

The communication device may implement one or more offset angles for communication with a remote communication device, such as an Rx offset angle ξ for an Rx optical path, a Tx offset angle α for a transmission optical path, and a rotational offset angle θ. The Rx offset angle may comprise a vertical component ξ_{ν}, a horizonal component ξₕ, or a combination thereof. The Tx offset angle may comprise a vertical component α_{ν}, a horizonal component αₕ, or a combination thereof. The Tx offset angle α may be with respect to the optical axis 204.

By way of further explanation, the communication device may orient itself such that the optical axis 204 of the telescope 206 aligns with the incoming signal 202 from a remote communication device apparent direction of arrival. Alternatively, the communication device may orient the telescope 206 such that the optical axis 204 has an Rx offset angle ξ relative to the incoming direction of arrival. The Rx offset angle ξ may comprise a 1-component or 2-component Rx offset angle relative to the incoming direction of arrival. In practical applications, the Rx offset angle ξ may be much less than the telescope's field of view (FOV), such that both ξ and ξ+α are within the FOV. The local communication device may be designed to maintain the Rx offset angle ξ close to zero by adjusting a positioner of the Rx optical path, re-orienting the entire communication device, re-orienting the telescope, or a combination thereof.

In some scenarios, the disclosed communication device may implement offsets in both the Rx and Tx optical paths. For example, the communication device may implement an Rx offset ξₕ in the Rx optical path. The communication device may implement Tx offset α_{ν}, in the Tx optical path. The communication device may implement a rotation offset ξ around a rotational axis 212 and a single offset in either the Tx or Rx optical paths, such as a, (in the Tx) or ξ_{ν} (in the Rx). It may be an advantage to use some combination of these approaches if pointing of a communication device has complex requirements or constraints.

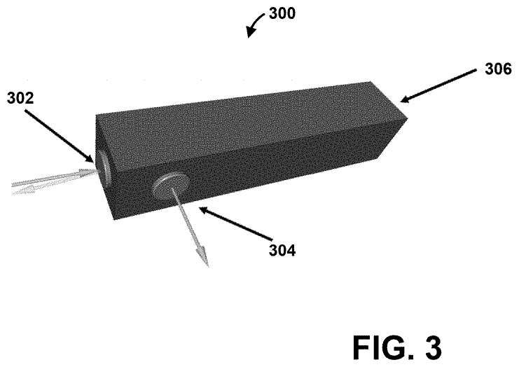

FIG. 3 shows an example optical beam separator. The example optical beam separator may comprise an optical device configured to separate Tx and Rx optical paths. The Tx optical path comprise a path between the optical beam separator and a transmitter, such as the optical source 120 of FIG. 1. The Rx optical path may comprise a path between the optical beam separator and a detector, such as the detector 118 of FIG. 1. The optical beam separator may be optically coupled to a common optical path between the optical beam separator and a fore optic (e.g., and to a remote communication device). The optical beam separator may be a beam splitter, a part-silvered mirror. Other optical devices may be used in some embodiments.

The optical beam separator may comprise a free space optical circulator (FSOC) as shown in FIG. 3. It should be understood that the communication device is not limited to this type of optical beam separator and the one shown is only for purposes of illustration. The optical beam separator may comprise a first port 302. The optical beam separator may comprise a second port 304. The optical beam separator may comprise at third port 306.

The first port 302 may be a common port for both the Rx path and the Tx path. The second port may optically couple the optical beam separator to the Rx optical path (e.g., to the detector). The third port 306 may optically couple the optical beam separator 330 to the Tx optical path (e.g., to the transmitter). Rx signals may enter the optical beam separator 300 via the first port 302 and exit the optical beam separator 300 by the second port 304. Tx signals may enter the optical beam separator 300 from the third port 306 and exit the optical beam separator from the first port 302. Port numbering is a convenience only, and any even permutation of ports one, two, and three may be substituted for ports one, two, and three. For example, it may be more convenient to use ports three, one, and two for telescope, Rx and Tx. The even permutations are: (1, 2, 3), (2, 3, 1) and (3, 1, 2).

Three-port devices with ports numbered 1, 2, and 3, where signal is directed primarily from ports 1-to-2, 2-to-3, and 3-to-1, are typically termed “circulators.” Circulators may be used in transceiver designs where a common antenna or telescope carries both incoming and outgoing signal. The circulator's passing signal from ports 1-2-3 rather than 3-2-1 may enable it to simultaneously direct incoming signal to the transceiver's receiver portion and to protect the receiver from the transmitter's much higher output power. The decibel ratio between signal loss in the 3-2-1 directions and the 1-2-3 directions is termed “directivity.”

In distinction from guided-wave circulators, the ports of a “free space” optical circulator (FSOC) may accept and emit many propagating modes with similar directions of propagation (or their reciprocal directions) over some field of view (FOV). The device ports may take the form of planar or lenticular windows. Signal beams, as described above in the background discussion, may enter a port (e.g., the first port 302), propagate through the circulator, and emerge, for example, from only one other port (e.g., the second port 304). The propagating modes of an FSOC may support multiple beams that may enter near a port's optical axis (e.g., the first port 302) and emerge from another port (e.g., the second port 304) while retaining their relative directions of propagation and other optical properties.

The FSOC's FOV may include all angles of propagation external to the FSOC supported in this manner, and their reciprocals. The FSOC's directivity, however, causes reciprocal-propagating signals to couple to different ports. Continuing the previous example, a received incoming signal at the first port 302 with a small offset angle ξ from the port's optical axis may propagate through the circulator and emerges ξ from the optical axis of the second port 304 (e.g., possibly with a rotation applied to ξ). At the same time, a Tx signal entering the third port 306 with a small offset angle α may emerge from the first port 302 with the offset α from the axis of the first port 302 (e.g., possibly with a rotation applied). For the case where a and ξ are both zero, the Tx signal's direction of propagation is the reciprocal of the incoming signal.

Thus, the free-space beam separation device supports incoming Rx beams and Tx beams with a small point-ahead offset. This may operate in the same way whether the device is a circulator or not. Both signals can propagate through the telescope (e.g., or the first optical path 110 of FIG. 1) simultaneously and the telescope pointing toward the remote communication device may optimize both Rx and Tx optical paths.

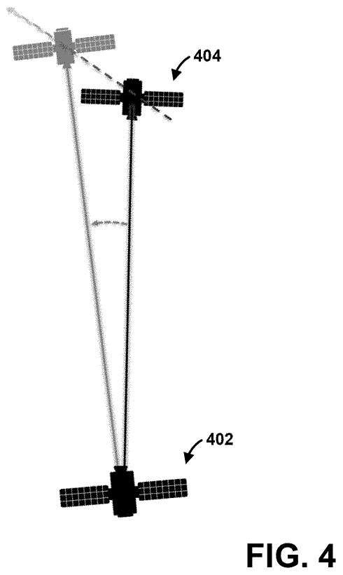

FIG. 4 shows an example of a point ahead offset between two communication devices. The illustration shows how a local communication device 402 (e.g., a local station), which may be a satellite in orbit, may need to point ahead of an apparent location of a remote communication device 404 (e.g., remote station, another satellite in orbit) by a Tx offset angle α. The remote communication device 404 may move relative to the local communication device 402 in the direction suggested by the dashed arrow. By the time the local communication device 402 return signal arrives at the remote communication device 404, the remote communication device's position and orientation relative to the local communication device 402 may have changed. Applying a Tx offset angle α may cause the transmitted signal to arrive at the actual location of the remote communication device 404, rather than the location of the satellite at the time of transmission. For this reason, the local communication device 402 may offset its transmit direction (gray line) from the apparent direction of arrival from the remote (black line). As an example, the second positioner 124 of example local communication device 102 of FIG. 1 may adjust the orientation of the Tx optical path 116 to apply the Tx offset angle α for optical signals being transmitted by the local communication device 102.

FIG. 5 shows an optical configuration of an example communication device 500. The example communication device 500 may comprise a satellite-borne station as shown. The example communication device 500 may comprise any of the features of the communication devices described elsewhere herein. A telescopic fore-optic 502 may receive an incoming light signal 504 and direct an outgoing signal 506 to a remote communication device. If the angular Rx-to-Tx offset is small, both beams may pass through a common optical path near its optical axis and with little (e.g., minimal) aberration.

An optical beam separator 508 (e.g., a circulator) may separate Tx and Rx paths. Along the Rx path, an offset tracker 510 may detects the Rx angle of arrival and maintains the optical axis relative to it. Following the offset tracker 510, a receiver 512 may be configured to receiver optical signals. An Rx path positioner may be integrated into the receiver 512 and/or separate from the receiver 512. The Rx path positioner may modify the angle of Rx signals to implement an Rx offset angle ξ. On the Tx path, a transmitter 514 may be configured to transmit optical signals. A Tx path positioner may be integrated into the transmitter 514 and/or separate from the transmitter 514. The Tx path positioner may modify the angle of Tx signals to implement a Tx offset angle α. One or more of the Rx offset angle ξ or the Tx offset angle α may be adjusted by the corresponding positioners based on any signals, data, calculation, and/or analysis, such as any signals the offset tracker 510.

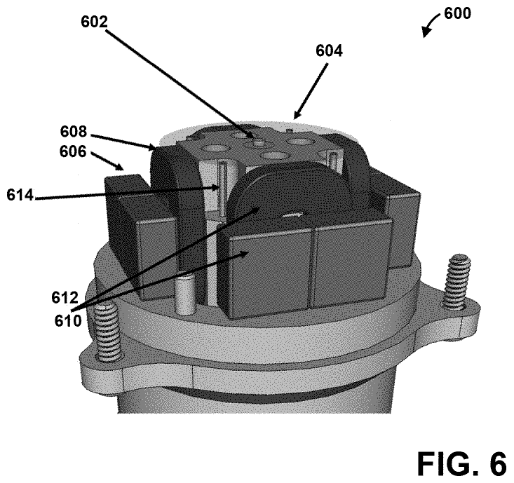

FIG. 6 shows an example positioner for offset control. Top cover and alignment components are not shown in the figure to make the positioning components visible. The example positioner 600 may implement h-direction and ν-direction offset control. The positioner 600 may be implemented as an Rx positioner, a Tx positioner, or a combination thereof (e.g., if integrated into a common path with both Rx and Tx beams). In the case of a Tx positioner, the positioner may be configured to adjust a Tx horizontal offset angle αₕ, a Tx vertical offset angle α_{ν}, or a combination thereof. In the case of a Rx positioner, the positioner may be configured to adjust an Rx horizontal offset angle ξₕ an Rx vertical offset angle or a combination thereof.

The same deflection mechanism may be used for both Tx and Rx fibers. The positioner 600 may be disposed adjacent (e.g., around) an optical fiber 602. The optical fiber 602 is shown in relation to a focal plane 604 of the telescope of the communication device. The positioner 600 may comprise a first set of static magnets 606 and a first moving coil 608. The first set of static magnets 606 and the first moving coil 608 may be configured to adjust the position of the fiber in the horizontal direction (e.g., to cause deflection of optical signals for a specified offset angle). An electrical signal may be applied to the first moving coil 608 to apply a force to deflect signals in the optical fiber 602. The positioner 600 may comprise a second set of static magnets 610 and a second moving coil 612. The second set of static magnets 610 and the second moving coil 612 may be configured to adjust the position of the fiber in the vertical direction (e.g., to cause deflection of optical signals for a specified offset angle). An electrical signal may be applied to the second moving coil 612 to apply a force to cause deflection of signals in the optical fiber 602. The positioner 600 may comprise flexible support rods 614 to support the optical fiber 602.

For configurations that allocate a single offset direction to either Tx, Rx or both, a single pair of coils and 4 static magnets may be used. Optical fibers may be single-mode fibers (SMF) for the signal wavelength. SMFs may offers benefits over other guided-wave structures for both Tx and Rx signal path processing. For optimal coupling between free-space and guided wave propagation, the positioner 600 may couple the telescope's field distribution and adjust and ξ (for Rx) or α (for Tx) for distant sources to well within the SMF core.

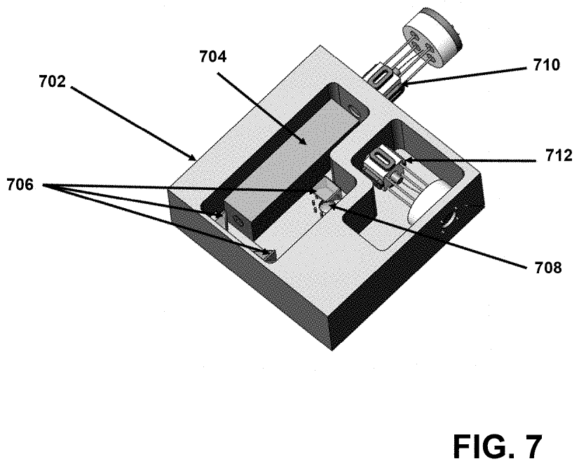

FIG. 7 shows example components of an example communication device. The components may be components stored in a housing 702 (e.g., the housing 108 of FIG. 1, housing 208 of FIG. 2) of an example communication device. The example communication device may comprise an optical beam separator 704 (e.g., optical beam separator 112, optical beam separator 300). The example communication device may comprise one or more optical redirection components 706, such as mirrors, prisms, and/or the like. The one or more optical redirection components 706 may direct Rx signals from the optical beam separator 704 to an offset detector 708, such as an angular offset detector.

The components may comprise a Tx optical assembly 710. The Tx optical assembly 710 may comprise a Tx optical fiber. The Tx optical fiber may be mounted on a Tx adjustment stage. The Tx adjustment stage may comprise at least one positioner as disclosed herein. The Tx adjustment stage may be configured to adjust a Tx offset angle α as disclosed herein.

The components may comprise an Rx optical assembly 712. The Rx optical assembly 712 may comprise an Rx optical fiber. The Rx optical fiber may be mounted on an Rx adjustment stage. The Rx adjustment stage may comprise at least one positioner as disclosed herein. The Rx adjustment stage may be configured to adjust an Rx offset angle ξ as disclosed herein.

In this example, the offset detector 708 (e.g., angular offset detector) may be positioned near the telescope's exit pupil. A 90-degree prisms may fold the optical path between the offset detector 708 and the optical beam separator 704 (e.g., circulator) first port (e.g., Port 1). The Tx signals (at Port 3) and Rx signals (at Port 2) may be carried by corresponding optical fibers and may be offset by 2-axis electromagnetic-coil deflection devices (TAECDs). With this perspective view shown in FIG. 7, the telescope optical axis is “down” and the telescope may be mounted beneath the optical receiver housing 702. The angular offset detector 708 may be used to position the system (e.g., the Rx signals, the Rx optical path, the Rx optical fiber, the Rx detector, or any combination thereof), such as to reduce (e.g., minimize) the Rx offset angle ξ (e.g., with respect to a detector). Small-offset control may be accomplished using the illustrated electromagnetic deflection coils. Other implementations may, by way of example, comprise geared positioners, piezoelectric deflectors, a combination thereof, or other means to implement fine offset positioning.

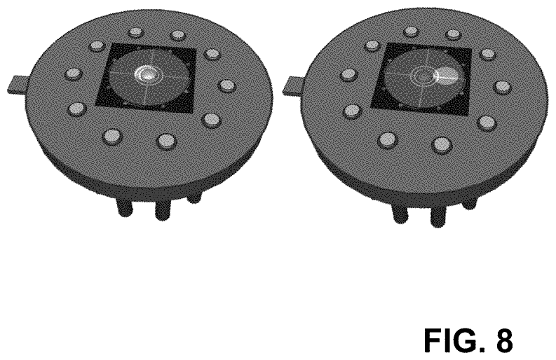

FIG. 8 shows example Rx offset angle ξ offset. A telescope may produce the resolution and clearest signal for communication when the remote communication direction of arrival (e.g., DOA is very close to the telescope optical axis). That is, when the magnitude of the Rx offset angle |ξ| is small compared with the telescope FOV. A communication device may therefore point the optical axis to a remote communication device using a combination of these techniques, as well as other means, such as any of the following. If the communication device is coupled to a vehicle such as a spacecraft, the communication device may modify the entire spacecraft attitude with thrusters, reaction wheels, magnetic torque or other means. Movable mirrors or prisms placed outside the telescope objective element may deflect or re-orient the optical axis. This may have an advantage over spacecraft re-orientation because the bulk to be moved is much smaller. An Rx offset angle ξ detector may include of an arrangement as described in U.S. Pat. No. 9,716,549, the disclosure of which is hereby incorporated by reference. The offset detector may enable the pointing system to maintain the received signal centered on the detector, as suggested by the lighter zone of the left image below. The system may accomplish this with a closed-loop control using one of the above means to re-orient the optical axis. This may increase (e.g., maximize) receiver performance.

In a case where it is desired to introduce some Rx offset angle ξ, for example, to reduce Tx offset from the optical axis, the same closed-loop control may be used, but now with a bias introduced so that the control loop maintains a small ξ-offset, as illustrated in the right-side image. By this technique, a system may implement Tx-and-Rx shared point ahead as discussed further herein, offsetting for αₕ in Tx only, and offsetting for α_{ν}, in Rx detects signal at offset α_{ν}.

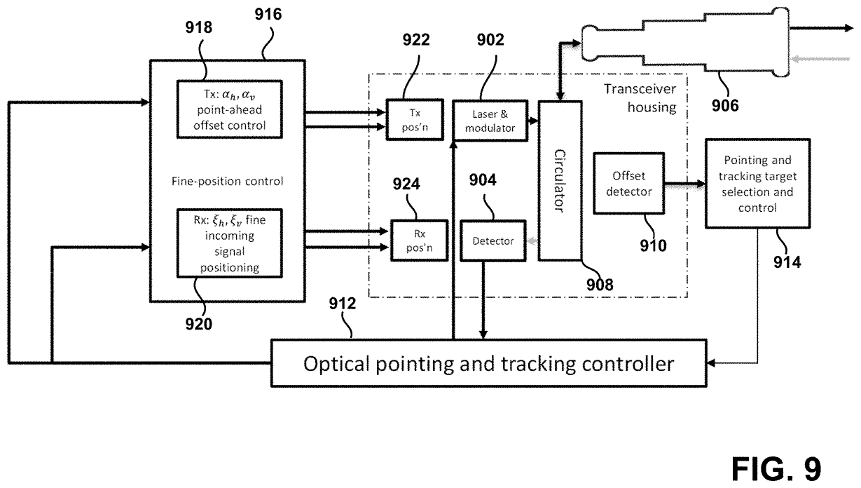

FIG. 9 shows an example point-ahead control system. The system may comprise a laser and modulator 902, a detector 904, a fore optic 906, a circulator 908 (e.g., or other optical beam separator), an offset detector 910, and/or the like. These components may comprise any of the features of these components described elsewhere herein. The system may comprise an optical pointing and tracking controller 912. The system may comprise a pointing and tracking target selection control 914. The pointing and tracking target selection control 914 may receive signals from the offset detector and providing information based on the signals to the optical pointing and tracking controller 912.

The optical pointing and tracking controller 912 may provide control signals and/or information to the fine position control 916. The fine position control 916 may comprise a Tx point-head offset control 918. The fine position control 916 may comprise an Rx fine incoming signal positioning control 920. The Tx point-ahead offset control 918 may be configured to cause adjustments (e.g., using control signals) to a Tx positioner 922. The Rx fine incoming signal positioning control 920 may be configured to cause adjustments (e.g., using control signals) to an Rx positioner 924. Tx positioner 922 may cause (e.g., based on control signals from the Tx point-ahead offset control) angular adjustments to Tx signals before transmission to a remote communication device. The Rx positioner 924 may cause (e.g., based on control signals from the Rx fine incoming signal positioning control 920) angular adjustments to Rx signals received from a remote communication device.

A point-ahead control system may be integrated with coarse pointing and fine pointing toward the remote communication device's apparent position as illustrated in the FIG. 9. Pointing may be initialized with a priori information about the remote communication device's relative position and orientation. An offset detector 910 and a received signal strength indicator (RSSI) in a modem of the local communication device may be used to jointly optimize pointing alignment with the incoming apparent angle of arrival. The pointing system (e.g., the optical pointing and tracking controller, the fine position control 916) may reorient the telescope to reduce (e.g., minimize) the Rx offset angle ξ.

Additional processing may improve (e.g., optimize) the Tx offset angle α. For the case where the Rx positioning accepts and compensates small values of ξ (as shown in earlier illustrations of this disclosure), α optimization may take the instantaneous commanded values of ξ into account, so that the Tx positioner tracks the vectorial sum of ξ+α.

Once communication is established, the Tx offset processor may also take RSSI reports from the remote communication device into account and optimize the Tx offset angle α for best signal at the remote communication station.

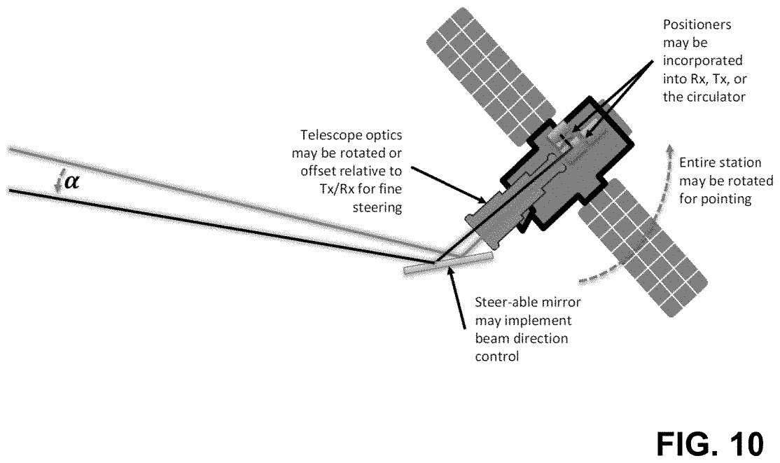

FIG. 10 show examples of controlling pointing of an example communication device. The illustration shows several mechanisms a communication device may use to implement alignment to the Rx direction of arrival, and to implement Tx offset angle α. In some embodiments, the communication device may require four degrees of freedom to point the Rx and Tx correctly. As noted elsewhere herein, a communication device may implement more than four degrees of pointing freedom for Rx and Tx, to support coarse and fine pointing.

In some implementations, a communication device may use small controlled deviations from optimal pointing, together with assessment of signal strength, to find the optimal direction for Rx. This is termed “dithering.” In these implementations, dithering may use different motions or degrees of freedom than general pointing to reduce (e.g., minimize) Rx offset angle ξ and/or implement a Tx offset angle α. It should be noted that even though the figure shows the optical beam separator (e.g., circulator) that may produce a 90° angle between the Tx and Rx paths, the optical beam separator itself may produce a variable deflection angle between the Tx and Rx beams (e.g.: deviating from 90°) as part of the point-ahead mechanism.

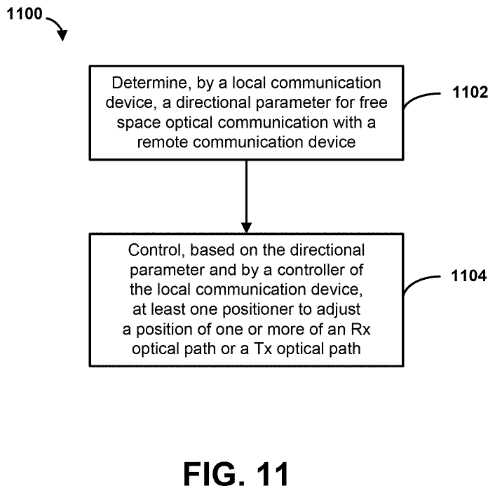

FIG. 11 is a flowchart showing an example method for free space optical communication. At step 1102, a directional parameter for free space optical communication with a remote communication device may be determined. The directional parameter may be determined by a local communication device. The directional parameter may comprise a transmission (Tx) offset angle as disclosed herein. The directional parameter may comprise a receiving (Rx) offset angle as disclosed herein. The directional parameter may comprise a combination of the Tx offset angle and the Rx offset angle. Determining the directional parameter may comprise determining the Tx offset angle, the Rx offset angle, any component thereof, and/or any combination thereof. The directional parameter may be determined based on offset signals from an offset detector. The directional parameter may be determined based on a point-ahead algorithm for determining that signals are transmitted to account for relative motion between the local communication device and the remote communication device.

The local communication device may comprise any of the components, features, and/or functionality of the communication devices disclosed herein, such as the local communication device of FIGS. 1-2, 5, and 9. The local communication device may comprise an optical beam separator, such as any of the optical beam separators disclosed further herein. For example, the optical beam separator may comprise one or more of an optical circulator, a beam splitter, a plate beam splitter, a polarization beam splitter, or a chromatic splitter. The optical beam separator may be configured to separate a first optical path into a receiving (Rx) optical path and a transmitting (Tx) optical path. The Rx optical path may be a single mode optical path. The Tx optical path may be a single mode optical path. The Rx optical path may comprise a first single mode optical fiber optically coupled to a detector for detecting received signals. The Tx optical path may comprise a second single mode optical fiber optically coupled with an optical source for generating signals.

At step 1104, at least one positioner may be controlled to adjust a position of one or more of the Rx optical path or the Tx optical path (e.g. with respect to respect to the optical beam separator). The at least one positioner may be controlled based on the directional parameter (e.g., to match one or more angles indicated by and/or associated with the directional parameter). The at least one positioner may be controlled by the local communication device (e.g., by a computer processor, controller, micro controller, circuit, field programmable gate array, and/or associated memory). The at least one positioner may be controlled to facilitate communication (e.g., by controlling alignment with) with the remote communication device via free space.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed:

1. A device comprising:
a first optical path configured to receive and transmit signals via free space;
an optical beam separator configured to separate the first optical path into a receiving (Rx) optical path for signals received from free space and a transmitting (Tx) optical path for signals being transmitted into free space;
at least one positioner coupled to one or more of the Rx optical path or the Tx optical path; and
a controller configured to control the at least one positioner to adjust one or more of the Rx optical path or the Tx optical path with respect to the optical beam separator to facilitate communication with a remote communication device via free space.

2. The device of claim 1, wherein the Rx optical path comprises a first single mode optical fiber optically coupled to a detector for detecting received signals.

3. The device of claim 1, wherein the Tx optical path comprises a second single mode optical fiber optically coupled with an optical source for generating signals.

4. The device of claim 1, wherein the optical beam separator comprises one or more of an optical circulator, a beam splitter, a plate beam splitter, a polarization beam splitter, or a chromatic splitter.

5. The device of claim 1, wherein the at least one positioner comprises a first positioner configured to adjust the Rx optical path and a second positioner configured to adjust the Tx optical path.

6. The device of claim 1, wherein the at least one positioner is configured to adjust one or more of the Rx optical path or the Tx optical path in at least two perpendicular directions orthogonal to a direction of signal propagation.

7. The device of claim 1, wherein the at least one positioner is configured to adjust one or more of the Rx optical path or the Tx optical path along a single direction orthogonal to a direction of signal propagation.

8. The device of claim 1, further comprising an offset detector configured to determine alignment signals for communication with the remote communication device, wherein the controller controls the at least one positioner based on the alignment signals.

9. The device of claim 1, wherein first optical path comprises a telescope configured to receive and transmit the signals via free space and a first optical fiber optically coupled to the optical beam separator.

10. The device of claim 1, further comprising a gimbal configured to adjust a direction of the first optical path.

11. A system comprising:
a remote communication device; and
a local communication device comprising:
a first optical path configured to receive and transmit signals via free space;
an optical beam separator configured to separate the first optical path into a receiving (Rx) optical path for signals received from free space and a transmitting (Tx) optical path for signals being transmitted into free space;
at least one positioner coupled to one or more of the Rx optical path or the Tx optical path; and
a controller configured to control the at least one positioner to adjust one or more of the Rx optical path or the Tx optical path with respect to the optical beam separator to facilitate communication with a remote device via free space.

12. The system of claim 11, wherein the Rx optical path comprises a first single mode optical fiber optically coupled to a detector for detecting received signals.

13. The system of claim 11, wherein the Tx optical path comprises a second single mode optical fiber optically coupled with an optical source for generating signals.

14. The system of claim 11, wherein the optical beam separator comprises one or more of an optical circulator, a beam splitter, a plate beam splitter, a polarization beam splitter, or a chromatic splitter.

15. The system of claim 11, wherein the at least one positioner comprises a first positioner configured to adjust the Rx optical path and a second positioner configured to adjust the Tx optical path.

16. The system of claim 11, wherein the at least one positioner is configured to adjust one or more of the Rx optical path or the Tx optical path in at least two perpendicular directions orthogonal to a direction of signal propagation.

17. The system of claim 11, wherein the at least one positioner is configured to adjust one or more of the Rx optical path or the Tx optical path along a single direction orthogonal to a direction of signal propagation.

18. A method comprising:
determining, by a local communication device, a directional parameter for free space optical communication with a remote communication device, wherein the local communication device comprises an optical beam separator configured to separate a first optical path into a receiving (Rx) optical path and a transmitting (Tx) optical path, and wherein the Rx optical path and the Tx optical path are single mode optical paths; and
controlling, based on the directional parameter and by a controller of the local communication device, at least one positioner to adjust a position of one or more of the Rx optical path or the Tx optical path with respect to the optical beam separator to facilitate communication with the remote communication device via free space.

19. The method of claim 18, wherein the Rx optical path comprises a first single mode optical fiber optically coupled to a detector for detecting received signals, and wherein the Tx optical path comprises a second single mode optical fiber optically coupled with an optical source for generating signals.

20. The method of claim 18, wherein the optical beam separator comprises one or more of an optical circulator, a beam splitter, a plate beam splitter, a polarization beam splitter, or a chromatic splitter.
